(19) United States
(12) Patent Application Publication
(10) Pub. No.: US 2026/0158719 A1
(43) Pub. Date: Jun. 11, 2026

(54) MANUFACTURING METHOD OF TWO-COLOR MOLDING PRODUCT AND MANUFACTURING APPARATUS

(71) Applicant: CANON KABUSHIKI KAISHA, Tokyo (JP)

(72) Inventors: RYO SATO, Kanagawa (JP); DAIKI YAMAMOTO, Kanagawa (JP); YUKUO YAMAGUCHI, Tokyo (JP)

(21) Appl. No.: 19/406,324

(22) Filed: Dec. 2, 2025

(30) Foreign Application Priority Data
Dec. 6, 2024 (JP) 2024-213228

(51) Int. Cl. B29C 45/44; B29C 45/16; B29K 21/00; B29K 23/00; B29L 31/00

(52) U.S. Cl. CPC B29C 45/4435; B29C 45/1676; B29K 2021/003; B29K 2023/12; B29L 2031/767

(57) ABSTRACT

Provided are an apparatus and a technique of suppressing a reduction in yield in molding of a two-color molding product. To this end, an undercut portion is formed by a first slide mold piece, and in a case of demolding the first slide mold piece, a second slide mold piece supports a sealing part.

### BACKGROUND

### Field of the Technology

The present disclosure relates to a manufacturing method of a two-color molding product and a manufacturing apparatus.

### Description of the Related Art

In general, a two-color molding product, which is formed of a primary molding product and a secondary molding product, is formed by molding the primary molding product first, and then injecting secondary molding resin into a secondary cavity formed by a movable mold holding the primary molding product and a secondary molding mold.

For example, to provide a complicated shape such as a hole in a side surface of a molding product, in general, a slide mold piece that drives in a direction orthogonal to an opening/closing direction of the mold is used. In this case, molding is performed in a state of advancing the slide mold piece. After the molding, the slide mold piece is retreated to perform mold opening, and the molding product is taken out.

Japanese Patent Laid-Open No. 2007-296773 discusses a configuration to stably operate the slide mold piece during molding.

In some cases, an undercut shape is formed in a case of using the slide mold piece. In this case, if the product molded by the slide mold piece is a part having elasticity, there is a possibility of damage/deformation when drawing the slide mold piece out of an undercut portion, and peeling occurs on an interface between the part and the molding product of other resin during two-color molding.

FIGS. 14A to 14C are diagrams illustrating a case where a slide mold piece 1401 is slid and an elastic part 1402 is molded by two-color molding according to the method discussed in Japanese Patent Laid-Open No. 2007-296773. As illustrated in FIG. 14A, resin injection is performed in a state in which the slide mold piece 1401 is inserted inside the molding product to mold the elastic part 1402. After the molding, as illustrated in FIG. 14B, the slide mold piece 1401 is drawn out in a downward direction. In this case, the elastic part 1402 is separated from the slide mold piece 1401 while deforming because of an undercut portion 1400. As illustrated in FIG. 14C, peeling may occur on an interface 1404 between a molding product 1403 molded by other resin and the elastic part 1402. In a case where peeling occurs on the interface 1404 between the molding product 1403 and the elastic part 1402, the molding product does not suitably function as a two-color molding product, and there is a possibility of a reduction in yield.

### SUMMARY

The present disclosure provides a technique to suppress a reduction in yield in molding of a two-color molding product.

An aspect of the present disclosure provides a method of manufacturing a two-color molding product that includes injecting first resin into a mold, as a first injection; injecting second resin into the mold, as a second injection; moving a first slide mold piece forming a part of a cavity in the mold in a moving direction after the first injection and the second injection, as a first sliding; and moving a second slide mold piece forming a part of the cavity in the mold in the moving direction after the first sliding, as a second sliding. The moving direction is different from an opening/closing direction of the mold. An undercut portion is formed by the first slide mold piece, by the first injection and the second injection. Movement of a product molded from the second resin in the moving direction in the first sliding is regulated by the second slide mold piece.

According to the present disclosure, it is possible to provide a technique to suppress a reduction in yield in molding of a two-color molding product.

Features of the present disclosure will become apparent from the following description of embodiments with reference to the attached drawings. The following description of embodiments is described by way of example.

### BRIEF DESCRIPTION OF THE DRAWINGS

FIG. 1 is an exploded perspective view of a print head used in a print apparatus;

FIG. 2 is a perspective view illustrating a main body portion forming a circulation unit;

FIG. 3 is an enlarged cross-sectional view illustrating a part of the main body portion;

FIG. 4 is a schematic view of prior art in which a general injection molding machine for two-color molding;

FIG. 5A is a diagram illustrating a slide mold piece in two-color molding;

FIG. 5B is a diagram illustrating the slide mold piece in two-color molding;

FIG. 6 is a diagram illustrating a surface of a movable side mold piece that is joined to a fixed side mold piece for secondary molding;

FIG. 7A is a cross-sectional view of a mold in a case of molding a body part in secondary molding;

FIG. 7B is a cross-sectional view of the mold in a case of molding the body part in secondary molding;

FIG. 8A is a cross-sectional view of the mold in a case of molding the body part in secondary molding;

FIG. 8B is a cross-sectional view of the mold in a case of molding the body part in secondary molding;

FIG. 9A is a cross-sectional view of the mold in a case of molding the body part in secondary molding;

FIG. 9B is a cross-sectional view of the mold in a case of molding the body part in secondary molding;

FIG. 10A is a cross-sectional view of the mold in a case of molding the body part in secondary molding;

FIG. 10B is a cross-sectional view of the mold in a case of molding the body part in secondary molding;

FIG. 11A is a cross-sectional view of the mold in a case of molding the body part in secondary molding;

FIG. 11B is a cross-sectional view of the mold in a case of molding the body part in secondary molding;

FIG. 12A is a diagram illustrating a gate position of a sealing part;

FIG. 12B is a diagram illustrating the gate position of the sealing part;

FIG. 13 is a diagram illustrating the sealing part as a comparative example;

FIG. 14A is a diagram illustrating prior art in which molding by a conventional method;

FIG. 14B is a diagram illustrating prior art in which molding by the conventional method; and

FIG. 14C is a diagram illustrating prior art in which molding by the conventional method.

### DESCRIPTION OF THE EMBODIMENTS

In the following, an embodiment of the present disclosure is described with reference to the drawings.

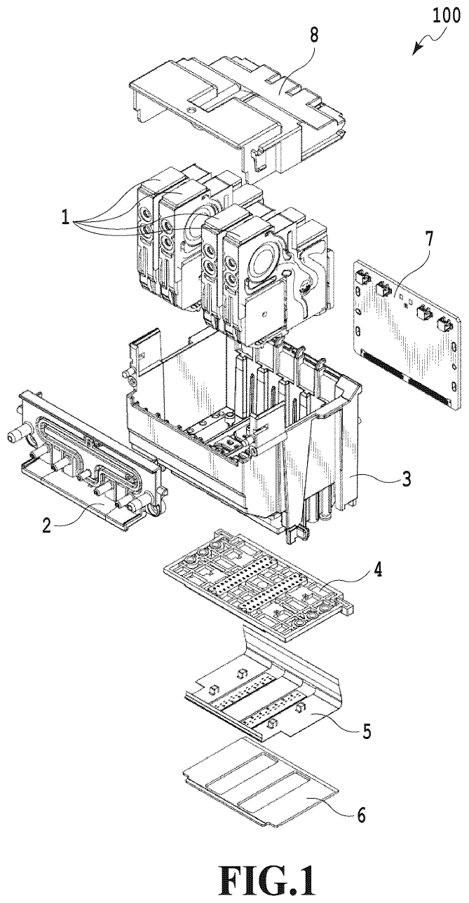

FIG. 1 is an exploded perspective view of a print head 100 used in a print apparatus. The print head 100 is connected with a print apparatus main body with a main body connection member 2 arranged therebetween, and ink supplied from the print apparatus main body to the print head 100 passes through a circulation unit 1 and is distributed by a flow channel member 3 based on color to be ejected from a print element substrate 5. The circulation unit 1 is stored inside the flow channel member 3 and covered with a top cover 8. Ink circulates through the circulation unit 1, a flow channel member 3, and the print element substrate 5. The print element substrate 5 is supported by a support member 4 and is covered with a bottom cover 6 is supplied with the ink, and the supplied ink is ejected based on a signal supplied from an electric wiring substrate 7. In the present disclosure, the circulation unit 1 of the print head 100 is molded by two-color molding.

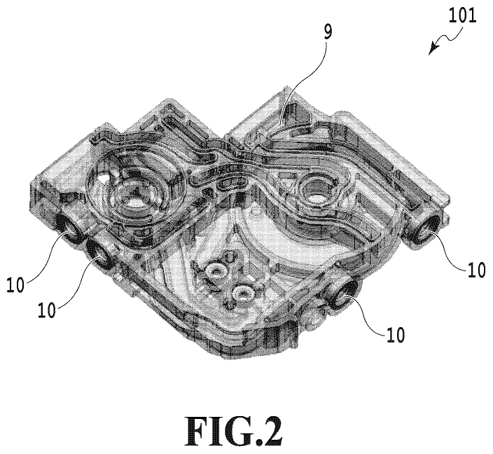

FIG. 2 is a perspective view illustrating a main body portion 101 forming the circulation unit 1. The main body portion 101 includes a body part 9 and four sealing parts 10 having elasticity. The four sealing parts 10 are embedded in the body part 9. The four sealing parts 10 function to suppress ink leakage in a connection port to supply and collect ink between the main body connection member 2 or the flow channel member 3 and the circulation unit 1.

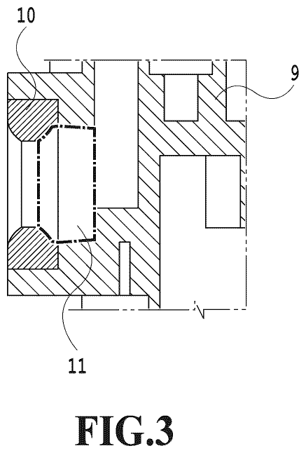

FIG. 3 is an enlarged cross-sectional view of a part of the main body portion 101. The sealing part 10 has a ring shape and is embedded inside an opening formed in the body part 9. The circulation unit 1 is embedded in the print head 100 by inserting a connection portion of the main body connection member 2 or the flow channel member 3 to the inside of the body part 9 through an opening of the sealing part 10. In this process, in order to prevent leakage of fluid such as the ink, the sealing part 10 needs to secure the sealing properties by elastic force. Therefore, in general, a member such as elastomer that has elasticity is adopted to be used for injection molding. With this configuration, it is possible to reduce the number of fastening members, such as screws, and to reduce the size of the print head 100.

In a configuration in which the body part 9 is molded first, an O ring of an elastic body is embedded as the sealing part. However, in this configuration, an apparatus to embed the O ring is required, and there is a possibility of contamination by a foreign matter during the embedding, and the sealing properties may deteriorate due to the foreign matter. Therefore, the body part 9 and the sealing part 10 are molded by two-color molding, which completes the steps within the same mold, to address the above-mentioned concerns. Particularly, in a case of a product using a liquid such as the print head, there may be a great restriction in a material of a member put in contact with the ink or a high requirement for the sealing properties. Therefore, it is difficult to introduce a countermeasure using a material, and it is necessary to address the problem by a manufacturing method.

In two-color molding illustrated in FIG. 3, in a case of removing a molded product, a slide mold piece positioned in an undercut portion 11 needs to be drawn out in a left-side direction in FIG. 3 while compressing the sealing part 10. In a case of FIG. 3, a space (i.e., a space surrounded by the dash-dotted line) that is on an inner side of the body part 9 than the sealing part 10 and has a greater shape than an inner periphery of the sealing part 10 is comparable to the undercut portion. When drawing out the slide mold piece positioned in the undercut portion 11, the sealing part 10 is deformed while the slide mold piece positioned in the undercut portion 11 passes through the inner periphery portion of the sealing part 10. Thus, a possibility arises that the slide mold piece damages the sealing part 10 or peels off a compatibilization portion between the body part 9 and the sealing part 10. In a case where peeling occurs on an interface between the body part 9 and the sealing part 10, the liquid leaks from the peeled portion, and thus a function of the circulation unit 1 is impaired.

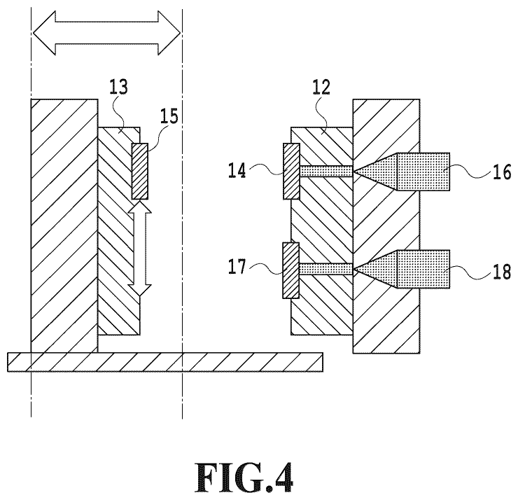

Here, a conventional general injection molding machine for two-color molding is described with reference to FIG. 4. The mold includes a fixed mold 12 and a movable mold 13 that are openable. Mold clamping is performed in a state in which a fixed side mold piece 14 for primary molding attached to the fixed mold 12 faces a movable side mold piece 15 attached to the movable mold 13 facing the fixed mold 12, and resin for primary molding is injected from a first gate 16. Thus, primary molding is performed. After the primary molding, mold opening is performed in which the fixed mold 12 and the movable mold 13 are separated from each other in an opening/closing direction, a primary molding product is held by the movable side mold piece 15. Thereafter, the movable mold 13 is moved to a secondary molding portion, mold clamping is performed again, and resin for secondary molding is injected from a second gate 18. Thus, secondary molding is performed by another fixed side mold piece 17 for secondary molding and the movable side mold piece 15.

The above described method is provided as a non-limiting example. Although a configuration in which the movable side mold piece 15 is moved in parallel in a vertical direction in FIG. 4 is described herein, a configuration in which the movable mold to which the movable side mold piece 15 is attached is rotated with respect to the fixed mold has been also known. As long as the mold piece is moved in the mold, the mold piece may be moved straight on the mold by an air cylinder and the like. Additionally, there are various methods, such as allowing for primary molding and secondary molding in multiple places and preparing the mold piece for each place, to perform primary molding and secondary molding concurrently in each place.

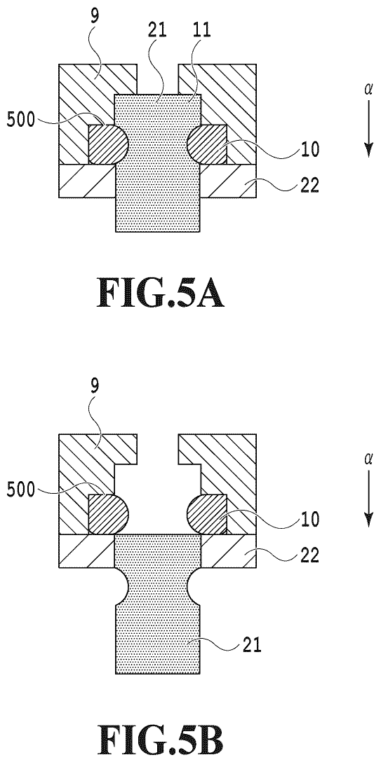

FIGS. 5A and 5B are diagrams illustrating movement of the slide mold piece after secondary molding in two-color molding of the present embodiment. In FIG. 5, for clarity, the fixed mold and the movable mold are not illustrated, and only the slide mold piece in the mold is illustrated. In the present embodiment, a first slide mold piece 21 and a second slide mold piece 22 are prepared as the slide mold piece.

FIG. 5A illustrates a state in which the body part 9 and the sealing part 10 are molded in a state in which the first slide mold piece 21 and the second slide mold piece 22 are inserted. FIG. 5B illustrates a state in which the first slide mold piece 21 is drawn out in an α direction after FIG. 5A. In the present embodiment, molding of the sealing part 10 is performed by using the first slide mold piece 21 and the second slide mold piece 22. The first slide mold piece 21 and the second slide mold piece 22 form a part of a cavity in the mold. The first slide mold piece 21 and the second slide mold piece 22 are formed to be able to individually slide (be movable) in the α direction (multistage slide). Here, after secondary molding is performed, the first slide mold piece 21 is slid in the α direction to be drawn out, and thereafter, the second slide mold piece 22 is also slid in the α direction.

In a case of sliding the first slide mold piece 21, the second slide mold piece 22 partially supports the sealing part 10, and thus deformation of the sealing part 10 in the α direction is suppressed. During the sliding of the first slide mold piece 21 in the α direction, in a case where a portion of the first slide mold piece 21 positioned in the undercut portion 11 passes through the sealing part 10, force in the α direction from the first slide mold piece 21 acts on the sealing part 10. Thus, force in a direction of peeling the sealing part 10 from the body part 9 acts on a compatibilization portion 500 between the body part 9 and the sealing part 10. The force on the compatibilization portion 500 may be suppressed by the second slide mold piece 22 regulating the movement of the sealing part 10 in the α direction. Thus, it is possible to suppress deformation of the sealing part 10 in a case of drawing out the first slide mold piece 21 and to suppress peeling at the compatibilization portion 500 between the body part 9 and the sealing part 10. After completion of the sliding of the first slide mold piece 21, the second slide mold piece 22 starts to slide in the α direction. Since the second slide mold piece 22 is not in a position of the undercut portion but is only put in contact with the sealing part 10, it is possible to slide the second slide mold piece 22 without deformation of the sealing part 10.

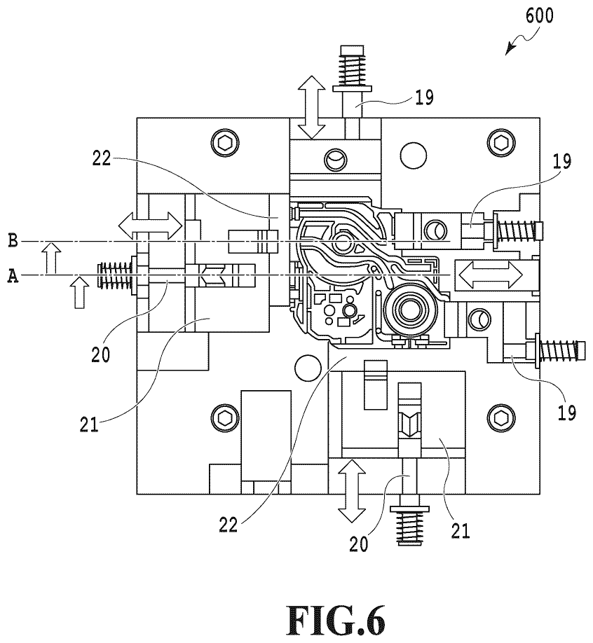

FIG. 6 is a perspective view illustrating a joining surface between the movable mold 13 and the fixed mold 12 in a manufacturing apparatus 600 of the present embodiment. In the manufacturing apparatus 600, multiple slides are provided to form a complicated shape such as a hole in a side surface that is not in the mold opening/closing direction. The manufacturing apparatus 600 includes a single stage slide 19 and a multistage slide 20, which performs multiple stages (two stages in the present embodiment) of sliding. The multistage slide 20 includes the first slide mold piece 21 forming the undercut portion 11 and the second slide mold piece 22 forming another shape. The first slide mold piece 21 and the second slide mold piece 22 can perform multistage sliding to slide individually. In FIG. 6, the multistage slides 20 are provided to two portions. For clarity, one multistage slide 20 (positioned on a left side in FIG. 6) is described herein, and a motion of sliding in each operation timing in a series of injection molding sequence is described with reference to each cross section.

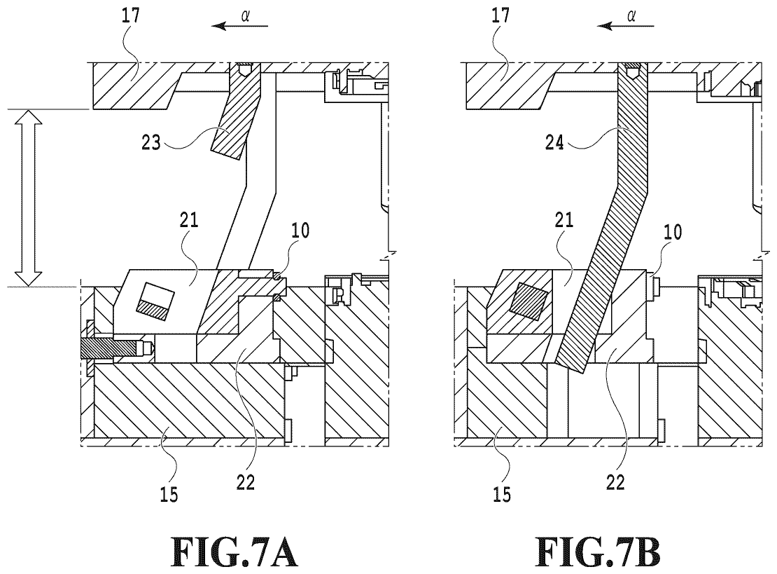

FIGS. 7A to 11B are enlarged views describing the movement of the multistage slide 20 in secondary molding. FIGS. 7A to 11B are diagrams illustrating a similar portion, with different timings of secondary molding. FIGS. 7A, 8A, 9A, 10A, and 11A are cross-sectional views taken along A in FIG. 6, and FIGS. 7B, 8B, 9B, 10B, and 11B are cross-sectional views taken along B in FIG. 6. Additionally, FIGS. 7A to 11B each illustrate a cross section in each timing in a case of molding the body part 9 by secondary molding after molding of the sealing part 10 is completed by primary molding. Although an example in which the sealing part 10 is molded by primary molding is described herein, the body part 9 may be molded by primary molding, and the sealing part 10 may be molded by secondary molding.

FIGS. 7A and 7B illustrate a state in which mold clamping in secondary molding is started, with the movable mold 13 at a lower level being moved toward the fixed mold 12 at a higher level. To be more specific, FIGS. 7A and 7B are cross sections illustrating timing of the operation in which a second angular cam 24 provided to the fixed mold 12 is put in contact with the second slide mold piece 22 provided to the movable mold 13. Here, the angular cam has an inclined portion at a tip with respect to the mold opening/closing direction, and the inclined portion of the angular cam allows the slide mold piece of the movable mold to move. On the other hand, a portion of the angular cam parallel to the mold opening/closing direction holds the slide mold piece. Once a distance between the another fixed side mold piece 17 for secondary molding and the movable side mold piece 15 is reduced by the mold clamping operation, the inclined portion of the second angular cam 24 allows the first slide mold piece 21 and the second slide mold piece 22 to start moving in a −α direction.

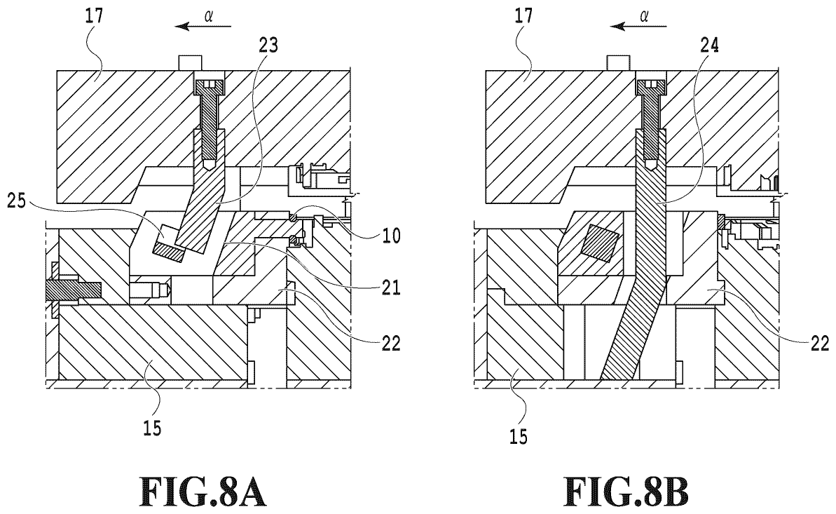

FIGS. 8A and 8B are cross sections illustrating timing in which the mold clamping further proceeds from FIGS. 7A and 7B, and a first angular cam 23 is put in contact with a tab part 25 of the first slide mold piece 21. The tab part 25 is configured to retreat from a part moving in a mold clamping direction and not to disturb the motion, but not to retreat from a part moving in a direction opposite the mold opening direction. Therefore, the first angular cam 23 does not allow the first slide mold piece 21 to move in the mold clamping direction but allows the first slide mold piece 21 to move in the mold opening direction. The first slide mold piece 21 and the second slide mold piece 22, moved in the −α direction by the inclined portion of the second angular cam 24, complete the movement in this timing and are held at a straight portion (a portion parallel to the opening/closing direction, i.e. a parallel portion) of the second angular cam 24.

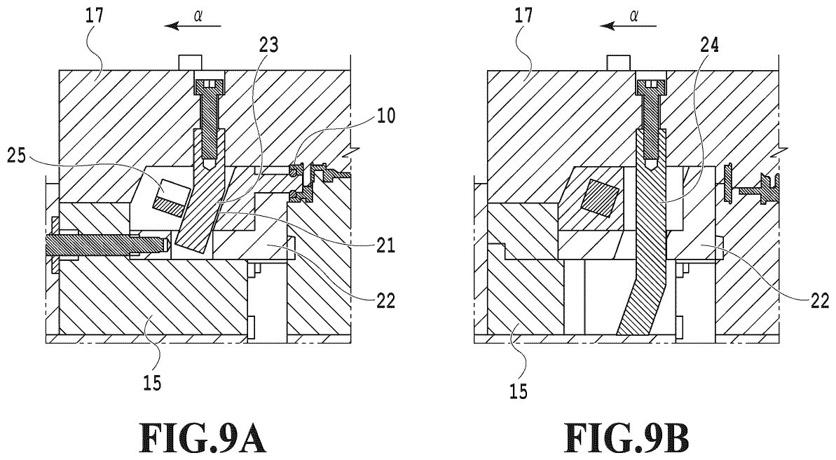

FIGS. 9A and 9B are cross sections illustrating timing in which mold clamping is completed. With completion of mold clamping, the inclined portion of the first angular cam 23 is put in contact with an inclined portion of the first slide mold piece 21, and the first angular cam 23 and the second angular cam 24 hold the first slide mold piece 21 and the second slide mold piece 22 to prevent movement. In this state, secondary molding (molding of the body part 9) is performed to complete the two-color molding product.

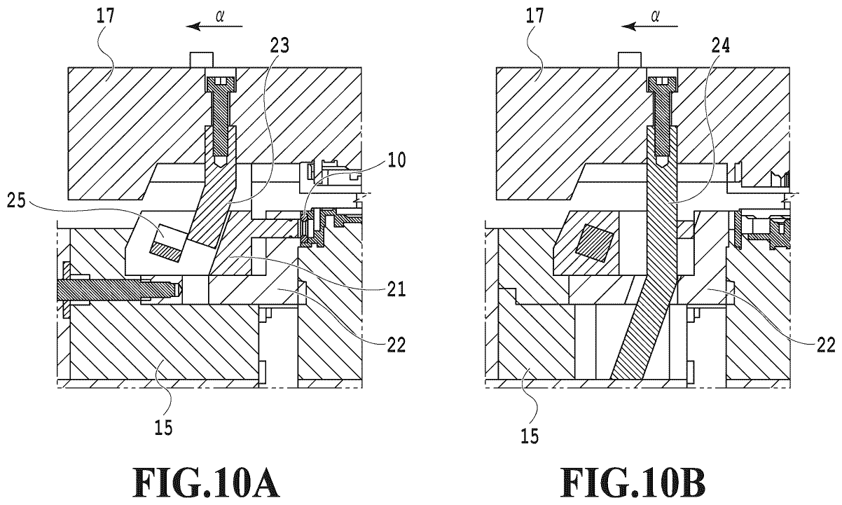

FIGS. 10A and 10B are cross sections illustrating timing in which mold opening is started after completing secondary molding, the first angular cam 23 is put in contact with the tab part 25 of the first slide mold piece 21, and the first slide mold piece 21 is moved in the α direction. As described above, since the tab part 25 is in a fixed state during mold opening, sliding of the tab part 25 along the inclined portion of the first angular cam 23 allows the first slide mold piece 21 to move in the α direction, and the first slide mold piece 21 is retreated from the portion forming the undercut portion. In this process, the second slide mold piece 22 is held by the straight portion of the second angular cam 24 to prevent movement and is pressed to prevent deformation of the sealing part 10. Thus, deformation of the sealing part 10 is suppressed in the α direction in a case of drawing the first slide mold piece 21 out of the undercut portion 11 (see FIG. 3), and damage on the sealing part 10 and peeling at the compatibilization portion 500 (see FIG. 5) between the body part 9 and the sealing part 10 are also suppressed.

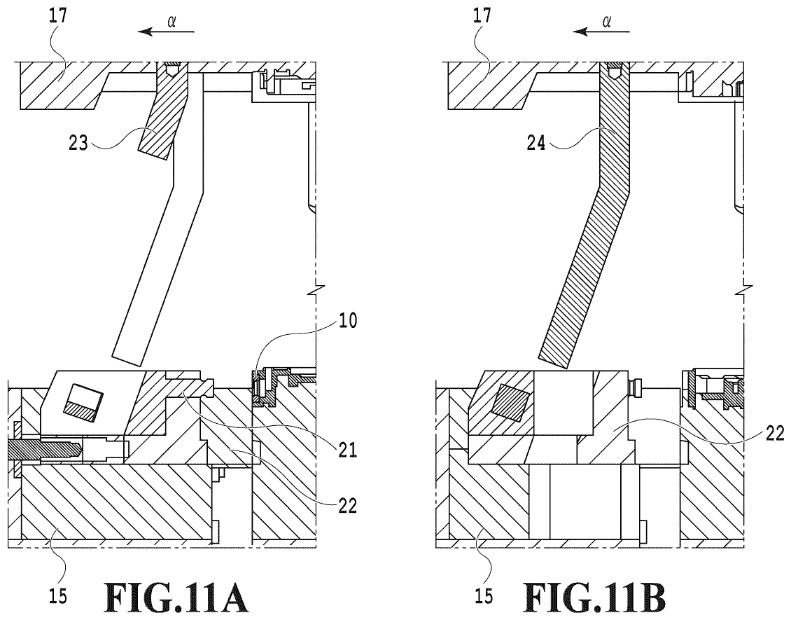

FIGS. 11A and 11B are cross sections illustrating timing in which the mold opening is completed. The inclined portion of the second angular cam 24 allows the second slide mold piece 22 to move in the α direction, and at the completion of the mold opening, the first slide mold piece 21 and the second slide mold piece 22 return to the initial positions. Thereafter, subsequent primary molding is performed, and then the above-described sequence is repeated to manufacture the two-color molding product.

In the circulation unit 1, the sealing part 10 is elastomer in general, and various types of resin such as polypropylene are used as the body part 9. Once the resin of the body part 9 contacts the sealing part 10 molded by primary molding, there is a tendency of strong joining due to compatibilization by heat and an anchor effect of the contact portion. On the other hand, there is a tendency of an increase in the difficulty of molding because the resin of the body part 9 enters the inside of the sealing part 10. Those tendencies become stronger as a melting temperature of the body part 9 increases above a melting temperature of the material of the sealing part 10.

In contrast, in a case where the body part 9 is molded by primary molding, and the sealing part 10 is molded by secondary molding, the body part 9 is already cooled down to some extent at the stage of secondary molding, and a flat surface is obtained. Thus, the strength of the joining to the sealing part 10 tends to be weak. Additionally, since the elastomer material is less likely to cause the resin to flow into the body part 9 due to the low melting temperature in general, the difficulty of the molding tends to be low.

The order of the molding products molded by primary molding and secondary molding depends on a type of the molding resin, molding conditions, a part shape, a required joining strength, and the like. Thus, selection of the order is performed, as needed. Additionally, in the present embodiment, a description of the slide mold piece moving orthogonally with respect to the mold opening/closing direction (in the moving direction), without being limited thereto. The driving direction of the slide mold piece may be other than the perpendicular direction with respect to the mold opening/closing direction, and it is also possible to arrange a two-color molding portion by providing an angle to the side surface of the product.

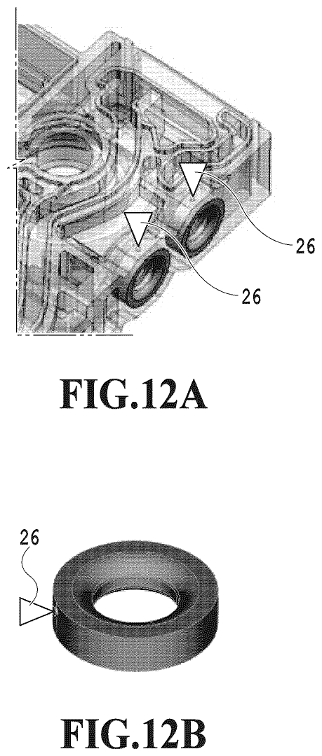

FIGS. 12A and 12B are diagrams illustrating a position of a gate 26 of the sealing part 10 in the present embodiment. In the present embodiment, molding of the sealing part 10 is performed by injecting the resin in the mold opening direction that is a vertical direction in FIG. 12A.

Because of the configuration of the mold, the direction of injecting the resin is easily arranged in the mold opening direction, that is, the gate may be arranged on a side surface of the ring shape, which is also advantageous as a product. As a flow of the molding resin, the inner periphery of the ring shape is filled first, and an outer periphery is filled at the end. In general, a small filling defect called a weld is likely to be generated in the last filling portion of the resin. That is, in the method of the present embodiment, the weld is likely to be generated in the outer periphery of the sealing part 10.

In a case where the weld is generated in a sealing portion, which is the inner periphery of the sealing part 10, a clearance is formed between the sealing portion and the other part to be put in contact with pressure, and there is a concern that the sealing properties is deteriorated, and leakage occurs. Therefore, with the gate 26 arranged on the side surface of the ring shape in the sealing part 10 as described in the present embodiment, the weld is unlikely to be generated in the inner periphery, and the defect is unlikely to occur.

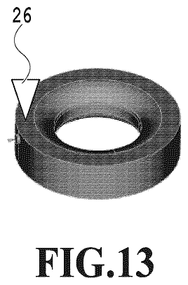

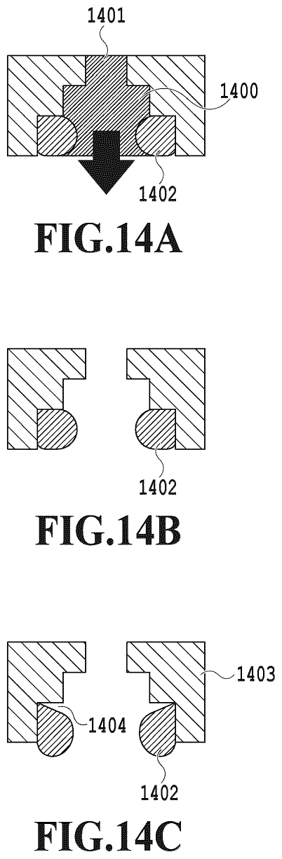

FIG. 13 is a diagram illustrating the sealing part having a gate position different from that in the present embodiment as a comparative example. In a case of creating the sealing part as a single part, usually, the position of the gate 26 is arranged as illustrated in FIG. 13. However, in this case, the resin flows in the outer periphery and the inner periphery of the sealing part almost concurrently, and the weld may also be generated in the inner periphery.

Although the multistage slide gradually is described to slide the two slide mold pieces, the present embodiment is not so limited, and a configuration of gradually sliding a greater number of the slide mold pieces may be applied.

Thus, the undercut portion 11 is formed by the first slide mold piece 21, and in a case of demolding the first slide mold piece 21, the second slide mold piece 22 supports the sealing part 10 having elasticity. Thus, a technique is provided of suppressing a reduction in yield in molding of a two-color molding product.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-213228, filed Dec. 6, 2024, which is hereby incorporated by reference herein in its entirety.

What is claimed is:

1. A method of manufacturing a two-color molding product, the method comprising:
injecting first resin into a mold, as a first injection;
injecting second resin into the mold, as a second injection;
moving a first slide mold piece forming a part of a cavity in the mold in a moving direction after the first injection and the second injection, as a first sliding; and
moving a second slide mold piece forming a part of the cavity in the mold in the moving direction after the first sliding, as a second sliding, wherein:
the moving direction is different from an opening/closing direction of the mold,
an undercut portion is formed by the first slide mold piece, by the first injection and the second injection, and
movement of a product molded from the second resin in the moving direction in the first sliding is regulated by the second slide mold piece.

2. The method according to claim 1, further comprising:
a first slide mold piece;
a second slide mold piece; and
an other mold configured to face the mold,
in the first sliding, along with separation between the mold and the other mold in the opening/closing direction, a first angular cam provided to the other mold moves the first slide mold piece in the moving direction, and
in the second sliding, along with separation between the mold and the other mold in the opening/closing direction, a second angular cam provided to the other mold moves the second slide mold piece in the moving direction.

3. The method according to claim 2, wherein:
in the first sliding, an inclined portion of the first angular cam and an inclined portion of the first slide mold piece slide to move the first slide mold piece, and
in the second sliding, an inclined portion of the second angular cam and an inclined portion of the second slide mold slide to move the second slide mold piece.

4. The method according to claim 2, wherein:
in a case where the mold and the other mold are closed,
the first slide mold piece is held by an inclined portion of the first angular cam with respect to the opening/closing direction, and
the second slide mold piece is held by a parallel portion of the second angular cam with respect to the opening/closing direction.

5. The method according to claim 2, wherein:
the first slide mold piece includes a tab part configured to contact with an inclined portion of the first angular cam in a case of mold opening of the mold and the other mold, and
the first slide mold piece moves in response to sliding of the inclined portion and the tab part.

6. The method according to claim 1, wherein
elastomer is used as the second resin.

7. The method according to claim 6, wherein:
a sealing part is formed of the second resin, and a body portion is formed of the first resin, and
the second resin becomes an elastic body.

8. The method according to claim 7, wherein
the second injection is performed after the first injection.

9. The method according to claim 7, wherein
the first injection is performed after the second injection.

10. The method according to claim 7, wherein
a gate to inject the second resin is arranged on a side surface of the sealing part having a ring shape.

11. An apparatus for manufacturing a two-color molding product, the apparatus comprising:
a mold configured to open in an opening/closing direction;
a first injection unit configured to inject first resin into the mold;
a second injection unit configured to inject second resin into the mold, the second resin configured to become an elastic body; and
a slide mold piece configured to move in a direction different from the opening/closing direction and form a part of a cavity in the mold, wherein
the slide mold piece includes a first slide mold piece configured to form an undercut portion and a second slide mold piece configured to regulate movement of a product molded from the second resin in a moving direction, in a case of demolding the first slide mold piece,
after the first slide mold piece is demolded, after the injection of the first resin and the injection of the second resin, the second slide mold piece is demolded, and
moving direction is different from the opening/closing direction.
